(19) United States
(12) Patent Application Publication
(10) Pub. No.: US 2015/0030814 A1
(43) Pub. Date: Jan. 29, 2015

(54) VEHICLE INTERIOR MEMBER

(71) Applicant: MEIWA INDUSTRY CO., LTD., Atsugi-shi (JP)

(72) Inventors: Takahiro OHMORI, Kani-shi (JP); Ryo YAMAGUCHI, Kani-shi (JP)

(21) Appl. No.: 14/320,699

(22) Filed: Jul. 1, 2014

(30) Foreign Application Priority Data
Jul. 26, 2013 (JP) 2013-155511

(51) Int. Cl. B60R 13/02; B32B 3/28; B32B 27/08; B32B 27/06; B32B 3/30; B32B 5/18

(52) U.S. Cl. CPC B60R 13/02; B32B 3/30; B32B 5/18; B32B 27/08; B32B 27/065; B32B 3/28; B32B 2250/03; B32B 2250/24; B32B 2250/40; B32B 2605/003
USPC 428/178

(57) ABSTRACT

A vehicle interior member includes a main body member having multiple recessed portions and raised portions and being made of a synthetic resin, a first plate-shaped member thermally welded on a front surface of the main body member, and a second plate-shaped member thermally welded on a back surface of the main body member. Each of the first plate-shaped member and the second plate-shaped member is a foamed sheet obtained by foaming a synthetic resin by adding a blowing agent to the synthetic resin.

### BACKGROUND OF THE INVENTION

1. Field of the Invention

The present invention relates to a vehicle interior member.

2. Description of the Related Art

To reduce carbon dioxide (CO₂), which causes the global warming, there has been a demand recently that the weight of a vehicle interior member be reduced to improve the fuel-efficiency of a vehicle. For the weight reduction of a vehicle interior member, methods are employed in which the number of parts constituting the vehicle interior member is reduced or the thickness of the vehicle interior member is reduced. However, it is possible that, when any of these methods is employed, performances required for the vehicle interior member cannot be satisfied because of decrease in rigidity.

### SUMMARY OF THE INVENTION

In addition, a vehicle interior member has been conventionally known which is made of a synthetic resin and which includes a main body member formed in a corrugated shape, a first plate-shaped member joined to a front surface of the main body member, and a second plate-shaped member joined to a back surface of the main body member. Each of the first plate-shaped member and the second plate-shaped member is joined to the main body member by pressing and welding the first plate-shaped member and the second plate-shaped member in a heated and softened state onto the main body member with rollers. For this reason, there is such a problem that traces of the pressed rollers are formed on the front surface of the first plate-shaped member and the back surface of the second plate-shaped member, and deteriorate the appearance quality of the vehicle interior member.

In this respect, Japanese Patent Application Publication No. 2005-297323 (hereinafter, referred to as Patent Document 1) discloses a plastic foam board having a large thickness and a high rigidity, as well as a high surface smoothness. As shown in FIG. 4, the plastic foam board has a cap sheet 1 having many recesses, a liner sheet 3 welded on an upper surface of the cap sheet 1 with a melt layer 4 interposed therebetween, and a back sheet 2 welded on a lower surface of the cap sheet 1 with a melt layer 4 interposed therebetween. Note that the melt layers 4 are melt layers of a propylene·α-olefin random copolymer.

In addition, Japanese Patent Application Publication No. Hei 6-170993 (hereinafter, referred to as Patent Document 2) discloses a plastic-corrugated board composite material 1 having a five-layered structure as shown in FIG. 2. The plastic-corrugated board composite material 1 includes a corrugated sheet 2, a foamed sheet 4 fusion-bonded to an upper surface of the corrugated sheet 2 with a liner 3 interposed therebetween, and a foamed sheet 4 fusion-bonded to a lower surface of the corrugated sheet 2 with a liner 3 interposed therebetween. Note that the liners 3 are made of a polyolefin-based resin.

However, the production of the plastic foam board according to Patent Document 1 requires an extruder for supplying the melt layer 4. Particularly when the liner sheet 3 and the back sheet 2 are welded to the cap sheet 1, two extruders are necessary. For this reason, there is a problem of increase in number of production apparatuses used for producing the plastic foam board.

Meanwhile, when the plastic-corrugated board composite material 1 according to Patent Document 2 is produced, first, a corrugated sheet formed in a corrugated shape is wound into a roll beforehand. Next, the foamed sheets are also wound into rolls beforehand. Then, while the corrugated sheet is continuously taken from the roll, the foamed sheets are also continuously taken from the rolls. Here, a molten resin, serving as a liner, is supplied between the corrugated sheet and each of the foamed sheets. Thus, the corrugated sheet 1 and each of the foamed sheets 4 are fusion-bonded to each other. For this reason, there is a problem of increase in production man-hours and in production costs.

In this respect, an object of the present invention is to provide a vehicle interior member retaining a conventional rigidity and having a high surface smoothness, without increase in production man-hours and production costs.

A vehicle interior member according to the present invention includes a main body member having multiple recessed portions and raised portions and being made of a synthetic resin, and at least one of a first plate-shaped member thermally welded on a front surface of the main body member and a second plate-shaped member thermally welded on a back surface of the main body member.

Each of the first plate-shaped member and the second plate-shaped member is a foamed sheet obtained by foaming a synthetic resin by adding a blowing agent to the synthetic resin.

### BRIEF DESCRIPTION OF THE DRAWINGS

FIG. 1 is an exploded perspective view showing a vehicle interior member according to a first embodiment of the present invention.

FIG. 2 is a cross-sectional view of FIG. 1.

FIG. 3 is a cross-sectional view of a vehicle interior member according to Comparative Example.

FIG. 4 is a cross-sectional view showing a vehicle interior member according to a second embodiment of the present invention.

FIG. 5 is a cross-sectional view showing a vehicle interior member according to a third embodiment of the present invention.

FIG. 6 is a plan view showing sheets used in Example of the present invention.

### DESCRIPTION OF THE EMBODIMENTS Hereinafter, embodiments of the present invention are described in detail with reference to the drawings.

### First Embodiment

### Configuration of Vehicle Interior Member

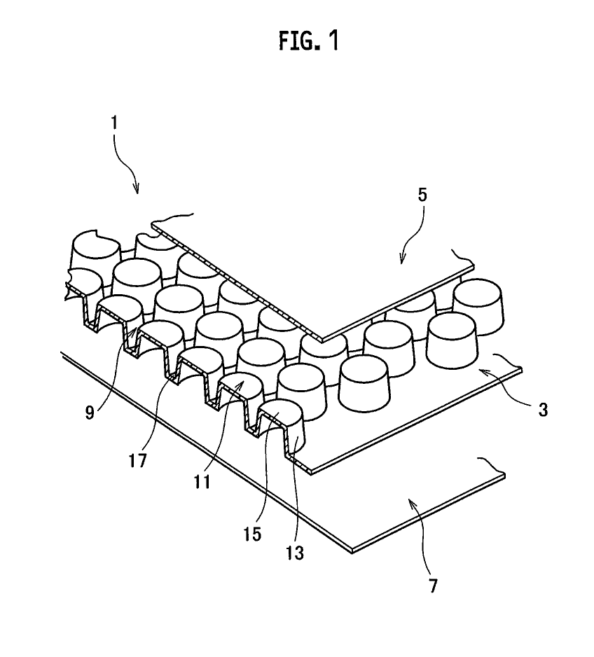

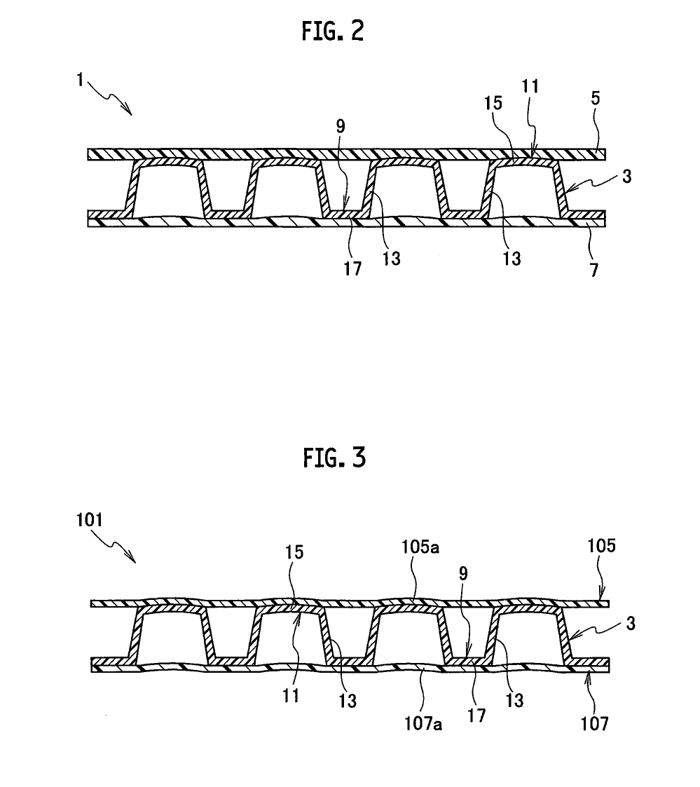

First, a first embodiment of the present invention is described. As shown in FIGS. 1 and 2, a vehicle interior member 1 according to the first embodiment includes a main body member 3, a first plate-shaped member 5, and a second plate-shaped member 7.

The main body member 3 has multiple recessed portions 9 and raised portions 11 and is made of a synthetic resin. Specifically, each of the raised portions 11 is formed in a circular truncated cone shape having a diameter gradually decreasing toward a top thereof, and formed as a single piece by a substantially cylindrical side face 13 and a disk-shaped top face 15 covering an opening at an upper end of the side face 13. In addition, each of the recessed portions 9 is formed as a single piece by the side faces 13 of the corresponding ones of the raised portions 11 and a bottom face 17 connecting lower ends of the side faces 13 to each other. Since the main body member 3 has the raised portions 11 and the recessed portions 9 as described above, the main body member 3 is formed with a high rigidity.

The first plate-shaped member 5 is a foamed sheet obtained by foaming a synthetic resin by adding a blowing agent to the synthetic resin and is thermally welded on a front surface of the main body member 3. Specifically, the first plate-shaped member 5 is thermally welded on the top faces 15 of the raised portions 11 of the main body member 3.

As in the case of the first plate-shaped member 5, the second plate-shaped member 7 is a foamed sheet obtained by foaming a synthetic resin by adding a blowing agent to the synthetic resin and is thermally welded on a back surface of the main body member 3. Specifically, the second plate-shaped member 7 is thermally welded on the bottom faces 17 of the recessed portions 9 of the main body member 3.

### Material of Vehicle Interior Member 1

Examples of materials which can be used for the synthetic resins for forming the main body member 3, the first plate-shaped member 5, and the second plate-shaped member 7 include polyolefin-based resins such as low-density polyethylene, high-density polyethylene, linear low-density polyethylene, homo polypropylene, random polypropylene, and block polypropylene; copolymers obtained from comonomers of any of these or from a comonomer of any of these and another monomer; polyvinyl chloride, chlorinated polyvinyl chloride, ABS, AAS, AES, polystyrene, polyethylene terephthalate, polycarbonate, polyamide, polyvinylidene fluoride, polyphenylene sulfide, polysulfone, and polyether ketone; copolymers obtained from comonomers of any of these or from a comonomer of any of these and another monomer; and the like. These materials may be used alone or in combination. Various thermoplastic resins can be used as described above. Here, a polypropylene-based resin is preferable considering the balance among costs and characteristics such as formability, physical properties, low-temperature resistance, and heat resistance.

In addition, when the rigidity of any of the main body member 3, the first plate-shaped member 5, and the second plate-shaped member 7 is increased, a filler may be blended as an auxiliary material. The auxiliary material is not particularly limited, and is preferably talc, calcium carbonate, or the like, considering the balance among costs, formability, and handleability. The costs and the specific gravity increase with the increase in amount of the filler added. Hence, considering the balance, the amount of the filler added is preferably 5 to 30% by mass in a case of talc and about 20% by mass or less in a case of calcium carbonate relative to the total weight. Moreover, in addition to the filler, an antioxidant, an ultraviolet absorber, an antistatic agent, an antibacterial agent, a flame retardant, a light stabilizer, a lubricant, and the like may be added, if necessary.

The vehicle interior member 1 has a thickness of preferably 3 to 10 mm. In other words, a total thickness of the main body member 3, the first plate-shaped member 5, and the second plate-shaped member 7 is preferably 3 to 10 mm. In addition, a weight per unit area of the vehicle interior member 1 is preferably 850 g/m² to 2000 g/m². If the weight per unit area is less than 850 g/m², the weight per square meter of the vehicle interior member 1 is light, and hence each of the main body member 3, the first plate-shaped member 5, and the second plate-shaped member 7 has a small plate thickness. In other words, when the first plate-shaped member 5 having a small plate thickness and the second plate-shaped member 7 having a small plate thickness are micro-foamed, the members are ripped or torn from foamed portions during extrusion of the molten resin from an extruder. Hence, the production rate decreases, and the production efficiency decreases.

As the blowing agent for foaming the first plate-shaped member 5 and the second plate-shaped member 7, for example, an organic blowing agent made of ADCA (azodicarbonamide) can be used, and the amount of the blowing agent added can be 1 to 3% by mass relative to the total weight. If the amount exceeds 3% by mass, the foaming occurs excessively, so that foamed cells are more likely to collapse during extrusion of the foamed sheets from extruders. On the other hand, if the amount is less than 1% by mass, almost no foaming occurs. Hence, as in a vehicle interior member 101 according to Comparative Example of FIG. 3, curved portions 105a and 107a due to the top faces 15 of the raised portions 11 and the bottom faces 17 of the recessed portions 9 of the main body member 3 are formed during extrusion on a front surface of a first plate-shaped member 105 and a back surface of a second plate-shaped member 107.

### Method for Producing Vehicle Interior Member 1

The vehicle interior member 1 according to the first embodiment can be produced, for example, by the following method.

First, a forming apparatus for forming the vehicle interior member 1 includes a main body member extruder, a second plate-shaped member extruder, a first laminating roll, a vacuum forming roll, a first plate-shaped member extruder, and a second laminating roll.

The main body member extruder extrudes a resin sheet for a main body member, which is to be the main body member 3, and supplies the resin sheet onto a peripheral surface of the vacuum forming roll. The second plate-shaped member extruder extrudes a second resin sheet, which is to be the second plate-shaped member 7, and supplies the second resin sheet onto a peripheral surface of the first laminating roll. The second resin sheet is wound on the peripheral surface of the first laminating roll. The resin sheet for a main body member is wound on the peripheral surface of the vacuum forming roll. Many recessed shapes each having a diameter of 7 mm and a depth of 5 mm are arranged in a check pattern on the peripheral surface of the vacuum forming roll. Hence, when the resin sheet for a main body member is wound on the peripheral surface of the vacuum forming roll, the main body member 3 having recessed portions and raised portions is formed. Here, the first laminating roll and the vacuum forming roll are arranged close to each other, and the peripheral surfaces of the first laminating roll and the vacuum forming roll are in contact with each other.

Moreover, the first plate-shaped member extruder extrudes a first resin sheet, which is to be the first plate-shaped member 5, and supplies the first resin sheet onto a peripheral surface of the second laminating roll. The main body member 3 and the second resin sheet fed from the vacuum forming roll and the first resin sheet from the first plate-shaped member extruder are supplied to the second laminating roll. Thus, the first resin sheet is thermally welded onto the main body member 3.

In addition, the resin sheet for a main body member is made of a thermoplastic resin (for example, polypropylene) having a melting temperature of 190° C. The first resin sheet and the second resin sheet are made of a thermoplastic resin (for example, polypropylene) having a melting temperature of 190° C. to which a blowing agent is added in advance. Note that the first resin sheet starts to foam when extruded from the first plate-shaped member extruder, and the second resin sheet starts to foam when extruded from the second plate-shaped member extruder.

First, the resin sheet for a main body member is extruded from the main body member extruder, and is pressed to the peripheral surface of the vacuum forming roll. Thus, the main body member 3 having many recessed portions 9 and raised portions 11 is formed.

Next, the second resin sheet is extruded from the second plate-shaped member extruder, and is supplied onto the peripheral surface of the first laminating roll. Meanwhile, the main body member 3 formed on the vacuum forming roll and the second resin sheet are adhered under pressure (thermal welded) to each other on the first laminating roll. Here, the second resin sheet is thermally welded onto the bottom faces 17 of the recessed portions 9 of the resin sheet for a main body member during the time the resin sheet for a main body member is on the peripheral surface of the vacuum forming roll and still has the heat applied at the time of the extrusion forming. Next, the integrated main body member 3 and the second resin sheet are detached from the peripheral surface of the vacuum forming roll. Then, the first resin sheet extruded from the first plate-shaped member extruder is placed on the top faces 15 of the raised portions 11 of the main body member 3, and the first resin sheet is thermally welded onto the top faces 15 of the raised portions 11 of the main body member 3 by the second laminating roll. Thus, the vehicle interior member 1 according to this embodiment is produced. Note that, at the time point when the forming by the second laminating roll is completed, the foaming of the first resin sheet and the second resin sheet is completed, and the first resin sheet and the second resin sheet are converted to foamed sheets, and have larger thicknesses than the resin sheets immediately after the extrusion from the extruders.

In addition, an expansion ratio of the first resin sheet and the second resin sheet is preferably 1.2 to 1.5. If the expansion ratio is less than 1.2, the foaming of the first plate-shaped member 5 and the second plate-shaped member 7 is insufficient. Hence, there arises a problem of deterioration in appearance quality, because, as shown in Comparative Example of FIG. 3, the curved portions 105a and 107a due to the recessed portions 9 and the raised portions 11 of the main body member 3 are formed during extrusion on the front surface of the first plate-shaped member 5 and the back surface of the second plate-shaped member 7. Meanwhile, if the expansion ratio exceeds 1.5, the foaming of the first plate-shaped member 5 and the second plate-shaped member 7 is excessive, and hence it becomes difficult to stably control the thickness of the vehicle interior member 1. Moreover, the appearance deteriorates, because the front surface of the first plate-shaped member 5 and the back surface of the second plate-shaped member 7 are coarsened by foamed cells. Note that the expansion ratio of the first resin sheet and the second resin sheet is further preferably 1.2 to 1.3.

Operations and effects of the first embodiment are described below.

(1) The vehicle interior member 1 according to the first embodiment includes the main body member 3 having the recessed portions 9 and the raised portions 11 and being made of a synthetic resin, the first plate-shaped member 5 thermally welded on the front surface of the main body member 3, and the second plate-shaped member 7 thermally welded on the back surface of the main body member 3. Each of the first plate-shaped member 5 and the second plate-shaped member 7 is a foamed sheet obtained by foaming a synthetic resin by adding a blowing agent to the synthetic resin.

As described above, in the vehicle interior member 1 according to this embodiment, the first plate-shaped member 5 and the second plate-shaped member 7, which are foamed sheets, are joined to the main body member 3 by thermal welding.

Hence, this eliminates the need for a step of applying a resin for adhesion (the melt layers 4 in Patent Document 1, or the liners 3 in Patent Document 2 mentioned above) for joining the first plate-shaped member 5 and the second plate-shaped member 7 to the main body member 3. For this reason, the production man-hours and production costs can be reduced.

In addition, in this embodiment, the first plate-shaped member 5 and the second plate-shaped member 7 are foamed sheets. Hence, the thickness of each of the first plate-shaped member 5 and the second plate-shaped member 7 is larger than the thickness of the liner sheet 3 and the back sheet 2 of Patent Document 1. Hence, the vehicle interior member 1 according to this embodiment has an improved rigidity against bending load.

Moreover, in this embodiment, the first plate-shaped member 5 and the second plate-shaped member 7 are foamed sheets. Hence, when the first plate-shaped member 5 and the second plate-shaped member 7 are thermally welded onto the main body member 3, the multiple recessed portions and raised portions formed in the main body member 3 are covered by the first plate-shaped member 5 and the second plate-shaped member 7, so that the surface smoothness of each of the first plate-shaped member 5 and the second plate-shaped member 7 is improved.

As described above, this embodiment makes it possible to obtain a vehicle interior member having a light weight, a high rigidity, and a high surface smoothness, with reduced production man-hours and reduced production costs.

(2) The expansion ratio of the foamed sheets of the first plate-shaped member 5 and the second plate-shaped member 7 is set to 1.2 to 1.5.

If the expansion ratio is less than 1.2, the foaming of the first plate-shaped member 5 and the second plate-shaped member 7 is insufficient. Hence, there arises a problem of deterioration in appearance quality, because, as shown in Comparative Example of FIG. 3, the curved portions due to the recessed portions 9 and the raised portions 11 of the main body member 3 appear on the front surface of the first plate-shaped member 105 and the back surface of the second plate-shaped member 107. Meanwhile, if the expansion ratio exceeds 1.5, the foaming of the first plate-shaped member 5 and the second plate-shaped member 7 is excessive, and hence it becomes difficult to stably control the thickness of the vehicle interior member 1. Moreover, the appearance deteriorates, because the front surface of the first plate-shaped member 5 and the back surface of the second plate-shaped member 7 are coarsened by foamed cells.

### Second Embodiment

Subsequently, a vehicle interior member 201 according to a second embodiment is described. However, portions having the same structures as those in the first embodiment described above are denoted by the same reference signs, and description thereof is omitted.

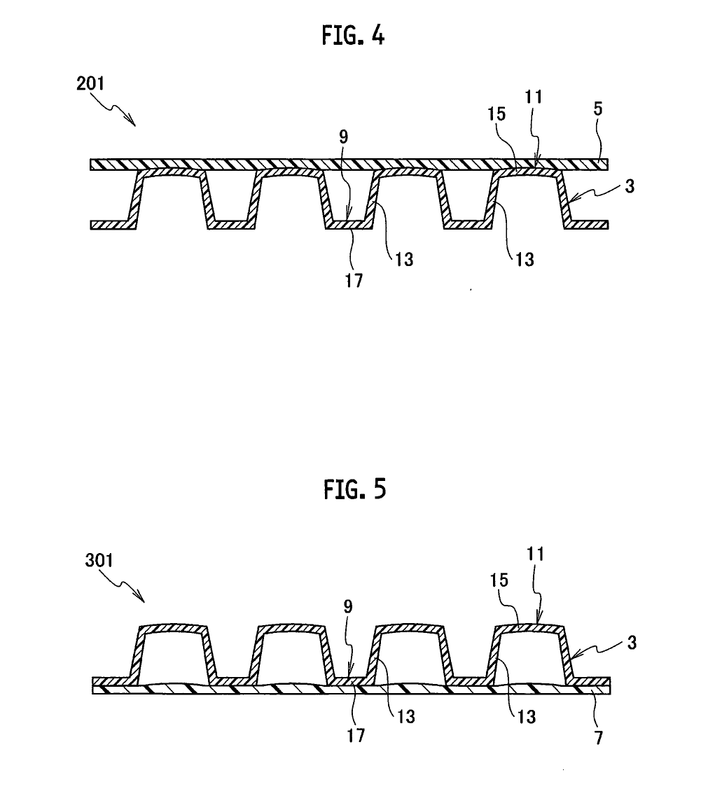

As shown in FIG. 4, the vehicle interior member 201 according to the second embodiment lacks the second plate-shaped member 7, in contrast to the first embodiment.

In other words, the vehicle interior member 201 includes the main body member 3 and the first plate-shaped member 5 thermally welded on the front surface of the main body member 3. Specifically, as in the first embodiment, the main body member 3 has the recessed portions 9 and the raised portions 11, and is made of a synthetic resin. Each of the raised portions 11 is formed in a circular truncated cone shape having a diameter gradually decreasing toward a top thereof, and formed as a single piece by the substantially cylindrical side face 13 and the disk-shaped top face 15 covering an opening at an upper end of the side face 13. In addition, the first plate-shaped member 5 is a foamed sheet obtained by foaming a synthetic resin by adding a blowing agent to the synthetic resin, and thermally welded on the top faces 15 of the raised portions 11 of the main body member 3.

The second embodiment makes it possible to obtain the same operations and effects as those in the first embodiment. In particular, the weight of the entire vehicle interior member 201 can be lowered, because of the lack of the second plate-shaped member 7.

### Third Embodiment

Subsequently, a vehicle interior member 301 according to a third embodiment is described. However, portions having the same structures as those in any of the first and second embodiments described above are denoted by the same reference signs, and description thereof is omitted.

As shown in FIG. 5, the vehicle interior member 301 according to the third embodiment lacks the first plate-shaped member 5, in contrast to the first embodiment.

In other words, the vehicle interior member 301 includes the main body member 3 and the second plate-shaped member 7 thermally welded on the back surface of the main body member 3. Specifically, as in the first embodiment, the main body member 3 has the recessed portions 9 and the raised portions 11 and is made of a synthetic resin. Each of the recessed portions 9 is formed as a single piece by the side faces 13 of the corresponding ones of the raised portions 11 and the bottom face 17 connecting the lower ends of the side faces 13 to each other. The second plate-shaped member 7 is a foamed sheet, and thermally welded on the bottom faces 17 of the recessed portions 9 of the main body member 3.

The third embodiment makes it possible to obtain the same operations and effects as those in the first and second embodiments. In particular, the weight of the entire vehicle interior member 301 can be lowered, because of the lack of the first plate-shaped member 5. Note that the vehicle interior member 301 according to the third embodiment is used with the second plate-shaped member 7 arranged on the front surface side.

The present invention is described in further detail below based on Example.

Specifically, a foamed sheet according to the present invention and a conventional resin sheet according to Comparative Example were subjected to a bending test based on JIS K7203 “Testing Method for Flexural Properties of Rigid Plastics.”

TABLE 1

| | | | Comparative |
|---|---|---|---|
| | Example | | Example |
| Thickness of sheet (mm) | Before foaming | 5.0 | 5.0 |
| | After foaming | 5.3 | |

| Weight per unit area of sheet | | 1200 | 1200 |
|---|---|---|---|
| (g/m²) | | | |
| Slope of | Longitudinal | 167.1 | 136.7 |
| bending | Transversal | 128.7 | 107.2 |
| elasticity | | | |
| (N/cm) | | | |

First, rectangular samples having a length of 50 mm and a width of 150 mm were prepared. As shown in Table 1, the sample according to Example was a foamed sheet, and had a thickness 5.0 mm before foaming and a thickness of 5.3 mm after foaming. In addition, the weight per unit area of the sheet was 1200 g/m². On the other hand, the sample according to Comparative Example was a conventional resin sheet, which was not foamed, and had a thickness of 5.0 mm. In addition, the weight per unit area of the sheet was 1200 g/m^{2.}

Next, each of the foamed sheet according to Example and the resin sheet according to Comparative Example was placed on jigs, which were arranged with a distance of 100 mm. Then, the center portion of the sheet in the longitudinal direction was gradually pushed at a rate of 50 mm/min to obtain a load-deflection graph.

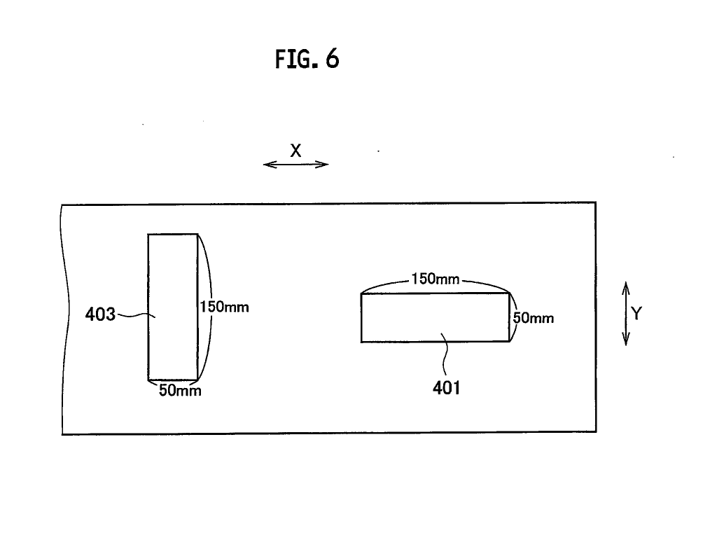

In the obtained load-deflection graph, a tangential line was drawn from the origin to the load-deflection curve, and the load at a deflection amount of 10 mm on the tangential line was calculated, and employed as the slope of bending elasticity. Table 1 shows the results. Note that the “Longitudinal” of the slope of bending elasticity means that when the sample was cut from a sheet wound into a roll shape, the longitudinal direction of the sample was the direction along a winding direction X, as shown in FIG. 6. In other words, a “Longitudinal” sample 401 has a length of 150 mm in the winding direction X of the roll and a length of 50 mm in a perpendicular direction Y perpendicular to the winding direction X. Meanwhile, a “Transversal” sample 403 has a length of 50 mm in the winding direction X and a length of 150 mm in the perpendicular direction Y perpendicular to the winding direction X.

As shown in Table 1, it was found that the foamed sheet according to Example had an improved slope of bending elasticity as compared with the resin sheet according to Comparative Example.

Note that the present invention is not limited to the above-described embodiments, and can be modified and altered in various manners. For example, a skin member such as a nonwoven fabric may be attached onto each of the front surface of the first plate-shaped member 5 and the back surface of the second plate-shaped member.

This application claims the benefit of priority from Japanese Patent Application No. 2013-155511, filed on Jul. 26, 2013, the entire contents of which are incorporated herein by reference.

1. A vehicle interior member comprising:
a main body member having a plurality of recessed portions and raised portions and being made of a synthetic resin; and
at least one of a first plate-shaped member thermally welded on a front surface of the main body member and a second plate-shaped member thermally welded on a back surface of the main body member, wherein
each of the first plate-shaped member and the second plate-shaped member is a foamed sheet obtained by foaming a synthetic resin by adding a blowing agent to the synthetic resin.

2. The vehicle interior member according to claim 1, wherein an expansion ratio of each of the foamed sheets of the first plate-shaped member and the second plate-shaped member is set to 1.2 to 1.5.
